(19) United States
(12) Patent Application Publication
(10) Pub. No.: US 2010/0126169 A1
(43) Pub. Date: May 27, 2010

(54) Internal combustion engine with two-stage register supercharging

(76) Inventor: Ronald Hegner, Friedrichshafen (DE)

Correspondence Address: KLAUS J. BACH, 4407 TWIN OAKS DRIVE, MURRYSVILLE, PA, 15668, US

(21) Appl. No.: 12/590,732

(22) Filed: Nov. 14, 2009

(30) Foreign Application Priority Data
Nov. 21, 2008 (DE) 10 2008 058 471.1

(51) Int. Cl. F02D 23/00; F01N 1/00

(52) U.S. Cl. 60/602; 60/324

(57) ABSTRACT

In an internal combustion engine with two-stage register charging, comprising an exhaust gas line including a flow control valve with a first outlet tube section leading to a low pressure turbine via a high pressure turbine and a second outlet tube section leading directly to the low pressure turbine, the flow control valve includes a flap for controlling the exhaust gas flow from the internal combustion engine so as to either block the exhaust gas flow or direct the exhaust gas to the low pressure turbine selectively through the high pressure turbine or directly to the low pressure turbine or simultaneously via both paths.

### BACKGROUND OF THE INVENTION

The invention resides in an internal combustion engine; with two stage register supercharging having an exhaust gas line including a flow control valve with a first outlet tube section including a high pressure turbine connected to a low pressure turbine and a second outlet tube section extending directly to the low pressure turbine bypassing the high pressure turbine, and an exhaust gas control valve with a control flap having a first position in which any flow through the valve is blocked, a second position in which exhaust gas flow through the second outlet tube section is blocked and all exhaust gas is directed through the high-pressure turbine and subsequently through the low pressure turbine and a third position in which both, the first outlet tube section with the high pressure turbine as well as the second outlet duct section leading directly to the low pressure turbine, are open.

A two-stage register supercharging arrangement generally comprises a first supercharger group which is always in operation and a controllable second supercharger group which can be activated selectively. Each supercharger group comprises a high pressure and a low-pressure exhaust gas turbocharger. The controllable supercharger group is activated or deactivated by way , of an exhaust gas flap valve which is usually controlled by an electronic engine control unit depending on the engine operation state.

A two-stage register supercharging arrangement with an exhaust gas flow control valve is disclosed for example in DE 39 03 563 C1. At the inlet side, the exhaust gas flow control valve is connected to a section of the exhaust gas duct. At the outlet side, the exhaust gas flow control valve is connected by way of a first tube section to the high pressure turbine and, by a parallel second tube section directly to the low pressure turbine. In a first position, the exhaust gas control valve flap deactivates the high pressure turbine and also the low pressure turbine as the exhaust gas valve flap closes the first as well as the second tube section. In a second position, the exhaust gas control flap directs the exhaust gas through the high pressure turbine and sequentially through the low pressure turbine and in a third position, the exhaust gas control valve flap provides for parallel flows of exhaust gas through the high pressure turbine and around the high pressure turbine to the low-pressure turbine. However, in practice, it has been found that it is desirable to rather direct the exhaust gas only to the low-pressure turbine.

It is therefore the principle object of the present invention to provide an internal combustion engine with two-stage register supercharging which provides in a simple manner for a greater freedom in the control of the exhaust gas flow through the turbocharger group providing for efficient utilization of the exhaust gas energy and a compact arrangement of the components involved.

### SUMMARY OF THE INVENTION

In an internal combustion engine with two-stage register charging, comprising an exhaust gas line including a flow control valve with a first outlet tube section leading to a low pressure turbine via a high pressure turbine and a second outlet tube section leading directly to the low pressure turbine, the flow control valve includes a flap for controlling the exhaust gas flow from the internal combustion engine so as to either block the exhaust gas flow or direct the exhaust gas to the low pressure turbine selectively through the high pressure turbine or directly to the low pressure turbine or simultaneously via both paths.

The invention will, become more readily apparent from the following description of a particular embodiment thereof on the basis of the accompanying drawings.

### BRIEF DESCRIPTION OF THE DRAWINGS

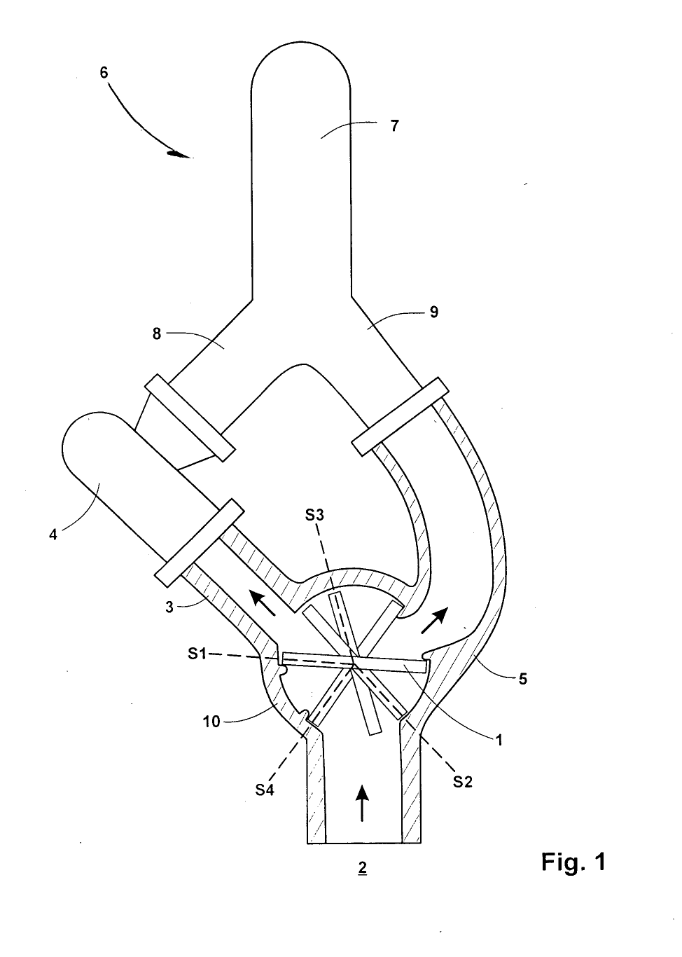

The sole FIG. 1 shows an internal combustion engine with an exhaust gas energy utilization arrangement including serially arranged high and low pressure exhaust gas turbines and a control valve for controlling the exhaust gas flow through the high and low pressure exhaust gas turbines.

### DETAILED DESCRIPTION OF A PARTICULAR EMBODIMENT

FIG. 1 shows an internal combustion engine M with an exhaust gas line 2 connected thereto and including an exhaust gas flow control valve with a flow control flap 1. The exhaust gas flow control valve is provided with a first tube section 3 including a high pressure exhaust gas turbine 4 which is connected to a low pressure turbine 6 and a second tube section 5 connected, in a parallel flow passage, to the low pressure turbine 6. The low pressure turbine 6 comprises, among others, a turbine housing 7 with first and second exhaust gas inlet feed pipes 8 and 9.

Via the first exhaust gas inlet feed pipe 8, the turbine housing 7 is connected to the high pressure turbine 4 and via the second exhaust gas inlet feed pipe 9, the turbine housing 7 of the low pressure turbine 6 is connected to the second tube section 5. The exhaust gas flow control flap 1 is disposed in a valve housing 10. In the figure, four possible positions S1, S2, S3 and S4 of the exhaust gas flow control flap 1 are shown.

In a first position S1, the high-pressure turbine 4 and the low-pressure turbine 6 are deactivated as the exhaust gas flow control flap 1 closes the first tube section 3 as well as the second tube section 5. In a second position S2 of the ex haust gas flow control flap 1, the first tube section 3 is open whereas the second tube section 5 is closed so that the exhaust gas flows sequentially through the high-pressure turbine 4 and the low-pressure turbine 6. In the third position S3 the exhaust gas flows to the low pressure turbine 6 through the high pressure turbine 4 and parallel via the second tube section 5, as the exhaust gas flow control flap 1 is in a position, in which both tube sections 3 and 5 are open. In the fourth position S4, the exhaust gas flow control flap 1 opens the second tube section 5 and closes the first tube section 3 so that the exhaust gas is directed only to the low pressure turbine 6.

As it is apparent from the figure, the four operating states S1-S4 can be realized via the exhaust gas flow control valve flap 1 by means of a compact arrangement.

### REFERENCE NUMERALS

1 exhaust gas flow control valve flap

2 exhaust gas line

3 first tube section

4 high pressure turbine

5 second tube section

6 low pressure turbine

7 low pressure turbine housing

8 first exhaust gas inlet pipe

9 second exhaust gas inlet pipe

10 valve housing

S1 first valve flap position

S2 second valve flap position

S3 third valve flap position

S4 fourth valve flap position

M internal combustion engine

What is claimed is:

1. An internal combustion engine with two-stage register charging, including:
an exhaust gas line (2) including a flow control valve having a valve housing (10) with a first outlet tube section (3) and including a high pressure turbine (4), a second outlet tube section (5) extending from the valve housing (10), a low pressure turbine (6) in communication with the control valve housing (10) via the first and, respectively, second outlet tube sections (3, 5), the flow control valve including an exhaust gas flow control flap (1) movable in the valve housing (10) between a first position (S1) in which the first tube section (3) as well as the second tube section (5) are closed so that the high-pressure turbine (4) and the low-pressure turbine (6) are deactivated, a second position (S2) in which the first tube section (3) is open while the second tube section (5) is closed so that the exhaust gas is directed sequentially through the high pressure turbine (4) and the low-pressure turbine (6), a third position, in which both tube sections (3, 5) are open so that the exhaust gas flows to the low pressure turbine via the high pressure turbine (6) and, in parallel therewith, via the second tube section (5), and a fourth position S4 in which the first tube section (3) is closed and the second tube section (5) is open so that the exhaust gas is directed to the low pressure turbine (6) only via the second tube section (5).

2. The internal combustion engine as defined in claim 1, wherein the turbine housing (7) includes a first exhaust gas inlet pipe (8) connected to the high pressure turbine (4) and a second exhaust gas inlet pipe (9) connected to the second tube section (5).
